(19) United States
(12) Patent Application Publication
(10) Pub. No.: US 2026/0279611 A1
(43) Pub. Date: Sep. 17, 2026

(54) NEUTRON SHIELDING MATERIAL

(71) Applicant: United Kingdom Atomic Energy Authority, Abingdon (GB)

(72) Inventor: David James Bowden, Abingdon (GB)

(73) Assignee: United Kingdom Atomic Energy Authority, Abingdon (GB)

(21) Appl. No.: 19/167,164

(22) PCT Filed: Mar. 22, 2024
(86) PCT No.: PCT/EP2024/057818

§ 371 Date: Sep. 19, 2025

(30) Foreign Application Priority Data
Mar. 22, 2023 (GB) 2304188.2

(51) Int. Cl. G21F 1/06; C04B 35/515; C04B 35/64; G21F 1/08

(52) U.S. Cl. CPC G21F 1/06; C04B 35/5158; C04B 35/64; G21F 1/08; C04B 2235/77; C04B 2235/95; C04B 2235/96

(57) ABSTRACT

A neutron shielding composite material is described, comprising a magnesium borate matrix and tungsten boride filler, optionally including additional fillers such as tungsten. Methods of manufacturing the composite material are also described.

### CROSS REFERENCE TO RELATED APPLICATION(S)

This application claims priority to International Application No. PCT/EP2024/057818, filed on Mar. 22, 2024, and United Kingdom Patent Application Serial No. 2304188.2, filed Mar. 22, 2023, the entire disclosures both of which are hereby incorporated by reference.

### TECHNICAL FIELD

The invention relates to materials suitable for nuclear reactor components, methods of their manufacture and their uses.

### BACKGROUND

Nuclear energy, for example civil fusion reactors, requires effective neutron shielding for safe operation. Tungsten borides (WB) are very effective neutron shielding materials but are difficult to manufacture. They require binder interphases, which are typically cobalt-based, to consolidate into sintered material blocks. These binders are problematic because they become radioactive in fusion environments. Although it is possible to manufacture monolithic tungsten boride, this is technically complex and costly.

Other neutron shielding materials are bulkier and less effective. It is therefore desirable to manufacture neutron shielding materials containing tungsten boride, without the drawbacks of existing tungsten boride shielding materials.

### SUMMARY

The invention provides a composite material comprising a matrix and a filler, wherein the matrix is magnesium borate and the filler comprises tungsten boride.

The filler may make up from 1 to 60 vol %, for example from 1 to 55 vol %, or 1 to 50 vol %, for example from 1 to 40 vol % (approximately 9-86 wt. %) of the composite, based on the total amount of starting materials. The filler may be particulate. A suitable particle size (Feret particle diameter) range is from 0.05 to 50 μm, such as from 0.05 to 40 μm, such as from 0.25 to 30 μm. In addition to tungsten boride, the filler may comprise one or more of tungsten, tungsten carbide, tungsten oxide, graphite and other suitable materials with neutron attenuation properties.

The composite material of the invention may suitably be in the form of a block. Such a block is typically ceramic. A block according to the invention may have a compressive strength of 11 to 13 MPa and/or a density of from 5 to 15 g/cm³. Block form of the inventive composite may be particularly suitable for use in modular construction. Blocks of the inventive composite can be manufactured using readily available equipment and methods and can be formed into a variety of shapes to meet construction constraints.

In block form, the composite may be manufactured such that the filler is not uniformly distributed. For example, the concentration of filler may exhibit a gradient through the thickness of the block. The filler may exhibit a compositional gradient through the thickness of the block in that the filler comprises a secondary filler component in addition to tungsten boride and exhibits from for example 100% tungsten boride at one surface of a block composite to 100% of the secondary filler component at the opposite surface of the block (a ratio of tungsten boride:secondary filler of from 100:0 to 0:100 through the thickness of the block). The secondary filler component may be one or more of tungsten, tungsten carbide, tungsten oxide, graphite or any other suitable material with neutron attenuation properties.

The composite material of the invention may be in the form of a particulate, for example a ceramic or metallic particulate. For applications where a lower degree of neutron attenuation is required, the inventive material in particulate form may be incorporated into another material. For example, concrete incorporating the inventive material in particulate form may be used for neutron attenuation in nuclear fission reactor plants in a thinner amount than concrete not incorporating the inventive material, thereby making the reactor assembly and/or the whole energy plant more compact.

The invention provides a neutron shield assembly. The neutron shield assembly comprises a layer of the inventive composite material disposed against a layer of tungsten. These two layers may be positioned sequentially in either order between a radiation source and an object or a living being to be protected from radiation. Preferably tungsten metal is placed closest to the neutron source in order to slow the fast neutrons, followed by the inventive composite material which can capture thermal neutrons. In a tokamak-type (magnetic confinement) fusion reactor, the assembly may comprise the inventive composite material interposed between a layer of tungsten and a layer of coolant. In this arrangement, the central solenoid is shielded from neutron radiation originating in the plasma.

The invention provides a method of manufacturing the composite material of the invention. The method comprises the steps:
a. providing particulate MgO and particulate filler, wherein the filler comprises tungsten boride;
b. mixing the particulate MgO and particulate filler to form a first mixture;
c. combining the first mixture with boric acid to form a second mixture;
d. sintering the second mixture to form the composite material.

In the method of the invention, the sintering step may be conducted at a temperature of from 200 to 300° C. The sintering step may be conducted at a pressure of from 25 to 35 MPa. These are relatively mild conditions for fabricating ceramics and for fabricating materials suitable for use in nuclear applications, making the composite of the invention attractive compared to materials requiring very harsh production conditions. These temperatures and pressures for sintering are attainable with standard ceramic hot press and sintering equipment, enabling easy scale-up of manufacture. With this standard equipment, it is possible to make custom shapes. For example, during sintering, the composite may take the shape of a custom die form. Modular, stackable blocks, for example, may be produced to enable simple, custom nuclear reactor design. The sintering step may alternatively be conducted at a pressure of from 25 to 200 MPa, for example from 30 to 175 MPa, for example from 35 to 150 MPa, for example from 35 to 100 MPa. The sintering step may include a sequence of alternating heat and pressure treatments at any temperature or pressure described. In such a sequence, the pressure treatment may be initiated only once the temperature of the sintering equipment has reduced to a temperature of less than 100° C., for example less than 75° C., for example less than 50° C., for example about 25-30° C. In other such sequences, the sintering may comprise performing a heating step at a temperature between 200° C. and 300° C., terminating the heating, and performing a pressure step while the system is cooling. The sintering step may comprise concurrent heat and pressure treatments at any of the temperatures and pressures described. In one example, the sintering step is conducted as a single step at a temperature of from 200 to 300° C. and at a pressure of from 25 to 200 MPa, for example from 25 to 50 MPa i.e., a sintering step comprising simultaneous heat and pressure treatment.

The invention also provides the use of the composite material of the invention as a neutron shield in a nuclear fusion or fission reactor, as a radiation shield in nuclear medicine applications, or as a radiation shield in aerospace applications, preferably as a neutron shield for a nuclear fusion reactor.

### BRIEF DESCRIPTION OF THE DRAWINGS

FIG. 1: SEM micrographs of magnesium borate matrix with tungsten and tungsten boride fillers;

FIG. 2: XRD trace of magnesium borate with tungsten boride filler, after sintering at 1000° C.;

FIG. 3: schematic of neutron shielding assembly including the inventive material;

FIG. 4: cross-sectional schematic of a solenoid with the neutron shielding assembly of FIG. 3.

FIG. 5: graph of relative toroidal field coil lifetime versus proportion of total inboard shield thickness for the inventive material;

FIG. 6: histogram of tungsten boride particle size distribution.

### DETAILED DESCRIPTION

### Matrix

The matrix material comprises, substantially consists of, or consists of magnesium borate. The matrix acts as a binder for the filler particles, so that the filler material may be utilized more easily as, for example, a neutron attenuation material. Magnesium borate as used in the invention may have stoichiometry Mg₃B₂O₆. Other stoichiometries of magnesium borate may be present in the composite of the invention.

Magnesium borate and its manufacture is described in GB1035811, inventor Donald Albert Gebbett. Magnesium borate is also known as jeanite.

Unlike conventional binders for tungsten boride, magnesium borate does not become severely radioactive when used in nuclear reactor components. Magnesium borate can be considered a reduced-activation material, targeting safe disposal without long-lived radionuclides within 100 years after plant shutdown. This is a major benefit of the material as a binder, because it simplifies and makes safer the disposal of end-of-life reactor components. In contrast, commonly-used binders such as cobalt become highly radioactive during use, requiring difficult and costly processes for safe disposal.

Another major benefit of magnesium borate as a binder for tungsten boride is its ease of manufacture. It can be manufactured and sintered at temperatures achievable in a domestic oven and at pressures achievable with a hand press. The ease of manufacture means that the final size and shape of a sintered block is not limited, such that the size and shape of the die can be varied to enable manufacture of bespoke component geometries. Blocks could be made in unit form for stacking, for example.

### Filler

The filler comprises tungsten boride. Preferably tungsten boride used in the invention has stoichiometry WB. WB has a tetragonal structure below 1200° C. Other stoichiometries of tungsten boride may be used in the invention, such as W₂B₅. As used herein, “tungsten boride” refers to any stoichiometry of tungsten and boron unless specified otherwise.

Including both tungsten and boron in the filler brings dual benefits for neutron attenuation. When used together, tungsten and boron are the most efficient neutron shielding materials available.

The filler is preferably in particulate form. The particle size and morphology is not especially limited, but particle diameter may preferably be in the range 0.05 to 50 μm, such as 0.05 to 40 μm, such as 0.05 to 30 μm, such as 0.25 to 30 μm. The filler particle size may be in the range of 0.1 to 10 μm. Other filler morphologies, such as fibres, are possible within the invention. Metallic filler in fibrous form may be beneficial for part strength, for example by providing pseudo ductility under tensile loading. The filler morphology and the method for blending the filler with the matrix may be chosen to achieve a homogeneous product and to minimize porosity in the product.

W metal is available commercially in powder form and may have a particle size distribution d₁₀ of at least 15 μm, such as about 21 μm. Tungsten boride may be milled to the size desired for inclusion in the composite. Particle size may be measured using SEM imaging, combined with visual inspection and measurement.

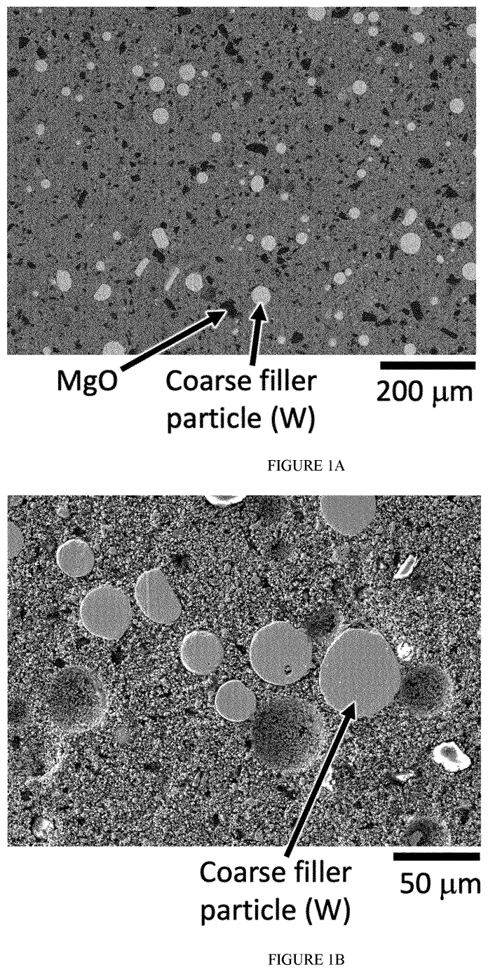

An analysis of WB particle size distribution is shown in FIG. 6. Particle size analysis was conducted using image analysis using FIJI-ImageJ (V2.1.0/1.53C). Image thresholding was applied to an SEM secondary electron image of the powder collected at 2000× magnification. An automated powder sizing routine was applied in FIJI-ImageJ, enabling the measurement of 1400 powder particles. The powder Feret diameter range was found to be 0.429-2.923 μm with an average powder Feret diameter of 1.03 μm. Fine WB filler consistent with this particle size distribution analysis is shown in FIG. 1C.

In addition to tungsten boride, the filler may comprise one or more of tungsten carbide; tungsten; tungsten oxide; graphite; and other filler materials with neutron attenuation properties, to provide neutron shielding across a wider energy range. Preferably the filler is a mixture of tungsten boride and tungsten. Using a gradient of different fillers may enable efficient use of the neutron attenuation capability of each element, for example slowing and then capturing neutrons within the same material, tailoring the filler gradient to the incoming direction of fast neutrons.

### Composite in Block Form

The composite may have a substantially granular structure and may include some micro-porosity. Micrographs of magnesium borate including WB and W filler particles are shown in FIG. 1. Each SEM micrograph is of a composite comprising 9:21 vol. % W:WB filler particles. In FIG. 1A, the coarse W particles are clearly visible. In FIG. 1B, the W particles can still be seen; the mottled background visible in this micrograph is made up of the fine blended WB. In FIG. 1C, with the highest magnification, the fine WB powder structure is more clearly visible. Neither WB nor W particles dissolve into the matrix during manufacture. FIG. 1A also shows large, unreacted MgO inclusions distributed throughout the matrix. The degree of porosity and the amount of MgO inclusions depends on the manufacturing method.

The concentration of filler may exhibit a gradient through the thickness of the block. For example, a combination of tungsten and tungsten boride may be used as fillers, with the volume % of filler being constant throughout the matrix, but the concentration ratio of tungsten to tungsten boride exhibiting a gradient of from 1:0 (all tungsten) through to 0:1 (all tungsten boride) across the thickness of the composite. In a neutron shielding assembly, the side of the block exhibiting the highest concentration of tungsten filler particles would be located closest to the radiation source, because pure tungsten is better at slowing fast neutrons, whereas tungsten boride is better at capturing slow neutrons.

Initial studies have found the composite block to have a compressive strength of 11 to 13 MPa, measured using Brazilian disc testing at room temperature, which is roughly twice the strength of concrete. Concrete is used extensively in the construction of conventional nuclear fission reactors. The composite material of this invention may be used as a substitute for concrete, for example where a compact design is required or there are special structural performance requirements that necessitate a higher strength material.

Initial studies have achieved a density of 8.17 g cm⁻³ when using a 9:21 vol % mixture of tungsten and tungsten boride, respectively, in a magnesium borate matrix. The magnesium borate matrix without any filler has a density of approximately 2.5 g cm⁻³.

### Composite in Particulate Form

Some applications do not require such high levels of neutron absorption as nuclear fusion reactors. For such applications, the required neutron absorption properties may be achieved whilst using less of the composite material, to save costs.

The composite material may be comminuted from block form to particulate form for incorporation into another material. For example, it may be combined with concrete and used for neutron attenuation in a conventional nuclear fission reactor. This may enable thinner concrete components to be used, allowing for a more compact reactor assembly. The composite may be manufactured using a die form that creates small blocks directly, to reduce or eliminate the need for a crushing step.

### Neutron Shielding Assembly

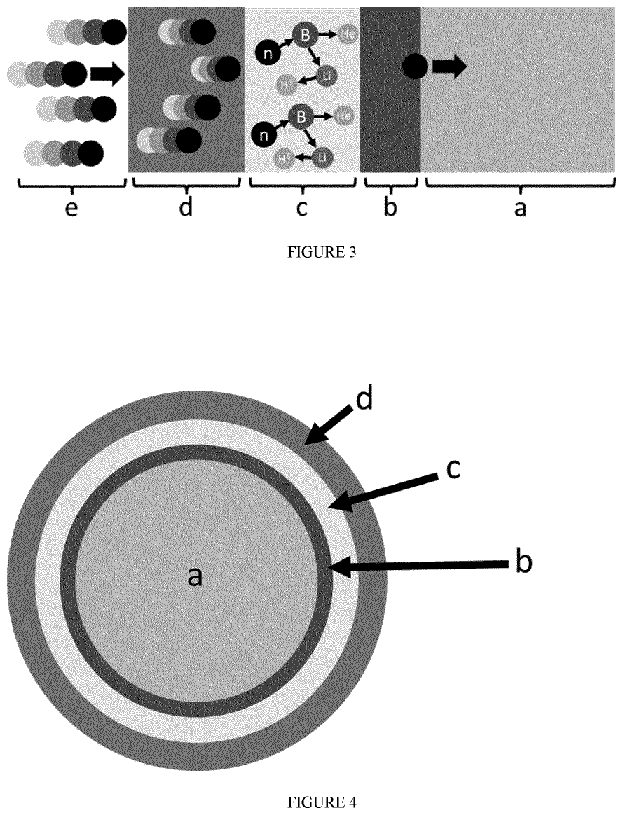

The composite material of the invention is especially suitable for use in any neutron shielding assembly. A schematic of one such assembly is shown in FIGS. 3 and 4. A central solenoid a is typically present in a tokamak-type fusion reactor in order to contain the plasma. The central solenoid must be protected from the neutron radiation that is emitted by the plasma. Coolant layer b offers thermal cooling and may provide a good level of thermal neutron capture for any neutrons not captured by the composite or metal shield layers. The inventive composite material is layer c in the assembly shown in FIGS. 3 and 4. The magnesium borate with tungsten boride filler captures thermal neutrons. A tungsten layer d acts as the first shield in the assembly and slows fast neutrons. Energetic neutrons entering the neutron shield assembly are shown schematically at e. Other arrangements of neutron shielding assemblies including the composite material of the invention are possible. For example, the coolant layer may be omitted, depending on the application. However, it will be appreciated that the composite material may be deployed in other areas in which neutron shielding is required, and that the example of shielding the central solenoid of a tokamak-type fusion reactor is only one such example.

### Manufacture

When making the composite in block form, the following basic procedure is followed: first, particulate magnesium oxide is mixed with the filler, forming a first mixture. Next, boric acid is combined with the first mixture, to form a second mixture. Boric acid may be substituted by another suitable boron compound, such as boric oxide or alkali metal borate. Finally, the second mixture is sintered. During the sintering step, the assumed reaction is:

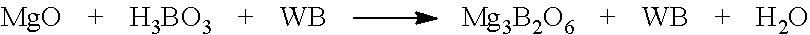

Preferably the sintering temperature is from 200 to 300° C. Preferably the sintering pressure is from 25 to 35 MPa. In one example, the sintering is performed at an elevated temperature and simultaneously an elevated pressure as described. That is, the sintering may comprise simultaneous heating and application of pressure at temperature and pressures as described. In other examples, the sintering may comprise sequential application of heat and pressure within the ranges described herein.

### Use of the Material

The design of the composite of this invention makes it especially suited for use as a neutron shield in nuclear fusion applications. For example, the composite may be used as part of a neutron shielding assembly in a tokamak-type reactor. Due to the design of a tokamak reactor, it is desirable to make thinner the neutron shielding material. The composite of the invention makes possible a thinner neutron shield than some known materials, whilst having a scalable manufacturing process and mechanically strong and stable bulk product. Fusion reactions generate a larger amount of neutron radiation than fission reactions for civil energy generation. The inclusion of tungsten and boron in the same material enables the fast neutrons from the fusion reaction to be slowed and captured in the same material. Further, the magnesium borate matrix is not highly activated, unlike previously-used binders such as cobalt. This makes the composite of the invention an attractive new option for neutron shielding in fusion reactor design.

Traditional fission reactors may also benefit from the composite of the invention as a neutron shielding material. Although the degree of neutron radiation is much less than for fusion reactors, the composite of the invention may be used to make much thinner neutron shields, thereby enabling compact reactor design. The composite of the invention may be made in particulate or granular form and incorporated into another material such as concrete. Such a tertiary composite may offer a balance between the low cost of concrete and the excellent neutron attenuation properties of the composite of the invention.

The composite may also be beneficial as a radiation shield in medical applications. Radiation sources in medicine are a beneficial treatment tool, but there is typically not very much space in which to provide radiation shielding. Given the efficiency of neutron shielding offered by the composite of the invention, it may suitably be implemented as a radiation shield in medical applications where neutron radiation must be addressed. In addition, tungsten is a known material for both X-ray and gamma radiation shielding due to its high density. Including tungsten metal alongside tungsten boride as filler material in the invention may enable medical radiation shielding components to be manufactured in a cheaper and more convenient manner than pure tungsten metal components.

Another application for the composite of the invention is in aerospace. Both people and components must be shielded from ambient radiation, which is experienced at a higher level in aerospace applications than at sea level. The composite may be implemented as a neutron shield in aerospace applications, in particular because it is thin, robust, and is lighter than some known radiation shielding materials. The composite may be used to attenuate radiation from a power source, or from cosmic radiation. The ability to manufacture the composite in custom shapes is particularly useful for these applications.

### EXAMPLES

### Example 1

Tungsten boride is indicated to be one of the most effective neutron shielding materials. However, it has previously been difficult to manufacture and required binder interphases such as cobalt to consolidate into blocks of material. Problematically these binders suffer from high activation in a fusion environment. Therefore, MgOB—WB composite ceramics according to the invention enable the utilisation of tungsten and boron in a low-activation MgOB matrix.

Block composites were made according to the invention. Tungsten boride filler particles were mixed with milled MgO, with up to 30 vol % being the tungsten boride filler particles. This combination was reacted with boric acid (H₃BO₃) at a ratio of 4.7:1:10 by volume of MgO to WB to boric acid (this ratio applies where tungsten boride is present in an amount of 30 vol %). The boric acid was used in concentrated, solid form having >99.5% purity. The reaction was conducted using sintering conditions of 200-300° C. and 30.9 MPa pressure for 20 minutes to produce a solid block of material. Without wishing to be bound by theory, the assumed reaction is:

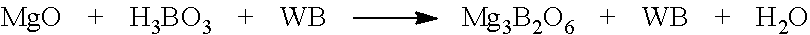

MgO is present in the product only when it has not completely reacted. The amount of unreacted MgO may be nil in some embodiments.

The products were found to have densities in the range 7.1 to 8 g cm⁻³.

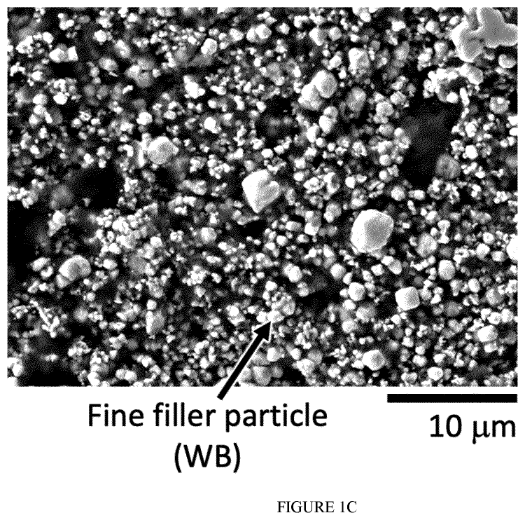

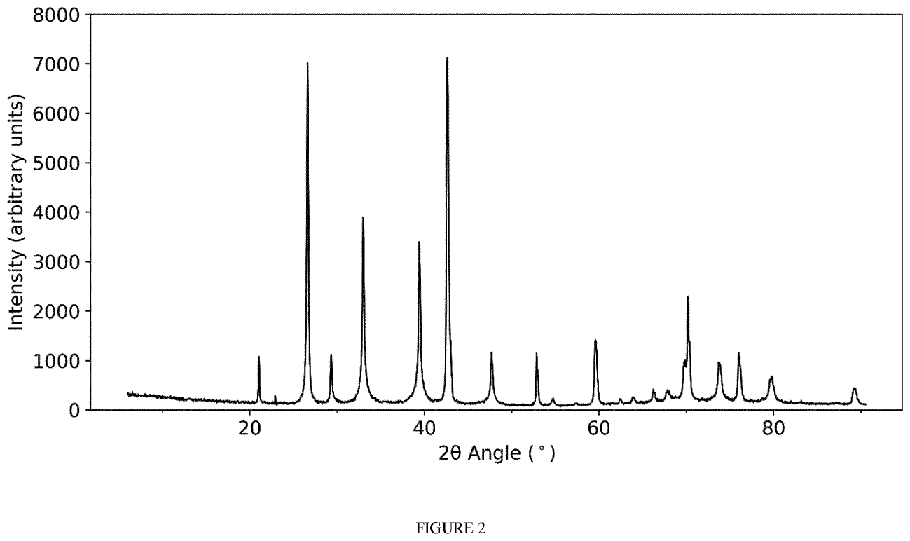

An XRD trace of a sample composite block of the invention is shown in FIG. 2. The sample had 10 vol % WB. The ratio of WB:MgO:H₃BO₃ was 1.3:1:10 by volume.

### Example 2

Modelling of neutron shield assemblies was conducted in which the amount of the inventive composite material used as the inboard shield as a proportion of total shield thickness was varied. In each model, the inventive composite material as the inboard shield was placed behind a pure tungsten outboard shield, i.e. the tungsten was closest to the plasma and the inventive material closest to the central solenoid. The shield in the model was water-cooled and the total shield thickness was 45.5 cm. The specific inventive composite used in the models was magnesium borate matrix with 21 vol. % WB filler and 9 vol. % W filler. The purpose of the modelling was to investigate toroidal field coil lifetime as a function of neutron shield material(s).

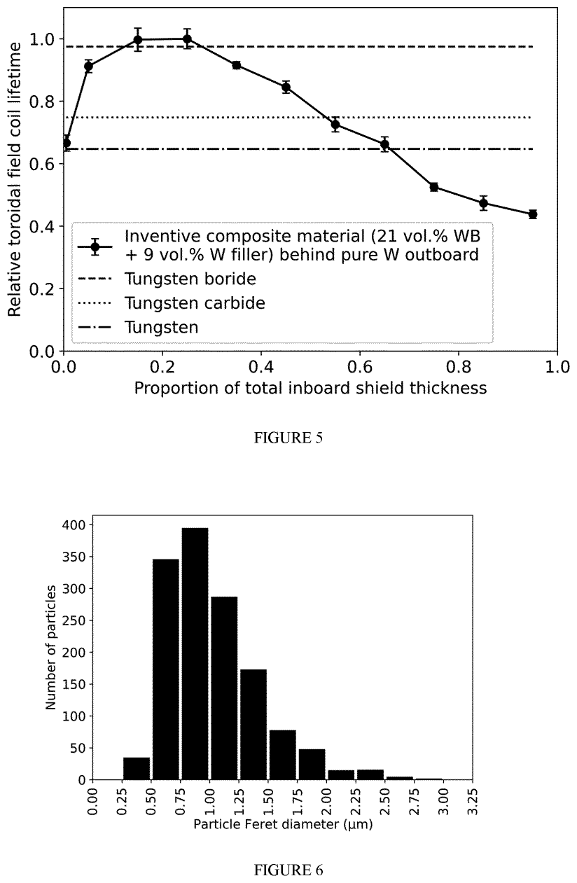

A graph of the results is shown in FIG. 5. The horizontal lines represent the relative toroidal field coil lifetime when the shield is pure tungsten, pure tungsten carbide and pure tungsten boride. Relative toroidal field coil lifetime indicates shielding effectiveness. When between 15-25% of the shield thickness was the inventive material and the remaining 75-85% shield thickness was tungsten, the shield combination was superior to a pure tungsten boride shield.

### Measurement Methods

Particle sizing analysis may be carried out using FIJI-ImageJ software, using the particle size analysis routine to produce an automated assessment of the size of 1400 particles from an SEM image.

### Benefits

In addition to the advantages mentioned above, the invention has the following benefits.
Provides an effective way to capture thermal neutrons, especially in the absence of moderating materials such as water.
Can be produced in solid blocks using very undemanding processes (<300° C.) and a hand operated press.
The use of reaction sintering (powder-based consolidation) enables a variety of die shapes to be used, and will allow useful block geometries in future (e.g. bricks to be stacked in shield region).
Composition utilises low activation elements (replacement of Co binder traditionally used for tungsten carbide and tungsten boride).
The use of different fillers within the material allows the composite shielding properties to be adapted for a range of neutron energies.
Integrity of material demonstrated up to 48 hours at 1000° C.

1. A composite material comprising a matrix and a filler, wherein the matrix is magnesium borate and the filler comprises tungsten boride.

2. The composite material of claim 1, wherein the filler makes up a volume percentage of the composite from 1 to 60 vol %, wherein the volume percentage is quoted relative to a total volume of starting materials.

3. The composite material of claim 1, wherein the filler further comprises one or more of tungsten, tungsten carbide, tungsten oxide and graphite.

4. The composite material of claim 1, wherein the filler consists of particles having a particle size between 5 to 50 μm.

5. A ceramic block consisting of the composite material of claim 1.

6. The ceramic block of claim 5, wherein the block has a compressive strength of 11 to 13 MPa.

7. The ceramic block of claim 5, wherein the block has a density of from 3 to 15 g/cm³, preferably from 5 to 15 g/cm³.

8. The ceramic block of claim 5, wherein a density of filler exhibits a gradient through a thickness of the block.

9. The ceramic block of claim 8, wherein the filler comprises tungsten boride particles and tungsten particles, wherein a concentration ratio of tungsten boride to tungsten exhibits a range from 1:0 to 0:1 across the thickness of the block.

10. A particulate ceramic comprising the composite material of claim 1.

11. A neutron shield assembly, comprising a layer of tungsten disposed against a layer of the composite material of claim 1.

12. The neutron shield assembly of claim 11, comprising a layer of coolant such that the layer of composite material is interposed between the layer of tungsten and the layer of coolant.

13. A method of manufacturing the composite material of claim 1 comprising:
a. providing particulate MgO and particulate filler, wherein the particulate filler comprises tungsten boride;
b. mixing the particulate MgO and particulate filler to form a first mixture;
c. combining the first mixture with boric acid to form a second mixture;
d. sintering the second mixture to form the composite material.

14. The method of claim 13, wherein the sintering is conducted at a temperature of from 200 to 300° C.

15. The method of claim 13, wherein the sintering is conducted at a pressure of from 25 to 200 MPa.

16. Use of the composite material of claim 1 as a neutron shield in a nuclear fusion or fission reactor, as a radiation shield in medical nuclear applications, or as a radiation shield in aerospace applications, preferably as a nuclear fusion neutron shield.
